(19) United States
(12) Patent Application Publication
(10) Pub. No.: US 2026/0238510 A1
(43) Pub. Date: Aug. 13, 2026

(54) TRANSCEIVER

(71) Applicant: Cirrus Logic International Semiconductor Ltd., Edinburgh (GB)

(72) Inventors: Michael CHANDLER-PAGE, Chesterfield (GB); Amr ELSLEHDAR, Newbury (GB); Jack FULLER, Newbury (GB)

(73) Assignee: Cirrus Logic International Semiconductor Ltd., Edinburgh (GB)

(21) Appl. No.: 19/529,577

(22) Filed: Feb. 4, 2026

Related U.S. Application Data
(60) Provisional application No. 63/757,144, filed on Feb. 11, 2025.

(51) Int. Cl. H04L 12/407

(52) U.S. Cl. CPC H04L 12/407

(57) ABSTRACT

A transceiver, the transceiver comprising: a first port; and a second port, wherein the first and second ports are each coupled to transmit circuitry and receive circuitry, and wherein the transceiver is operable in: a first mode of operation in which it transmits the same data from the first and second ports simultaneously; a second mode of operation in which it receives data at the first port and immediately transmits the received data from the second port; and a third mode of operation in which it receives data at the second port and immediately transmits the received data from the first port.

### FIELD OF THE INVENTION

The present disclosure relates to a transceiver, in particular a transceiver for a half-duplex communications system.

### BACKGROUND

There is an increasing trend in a wide range of industrial applications for embedded electronic systems. Such applications may benefit from a relatively simple, integrated and low-latency communication system that provides for improved efficiency and ease of use when installing, using and maintaining such a communication system.

One example of an application in which the provision of a relatively simple, integrated and low-latency communication system may be beneficial is in embedded electronic systems in vehicles, for example multi-speaker audio or infotainment systems.

Such systems can be used to transmit audio signals representing music or other audio content from a central node to remote speakers. Such systems may also be used for other purposes such as road noise cancellation.

### SUMMARY

According to a first aspect, the invention provides a transceiver, the transceiver comprising: a first port; and a second port, wherein the first and second ports are each coupled to transmit circuitry and receive circuitry, and wherein the transceiver is operable in: a first mode of operation in which it transmits the same data from the first and second ports simultaneously; a second mode of operation in which it receives data at the first port and immediately transmits the received data from the second port; and a third mode of operation in which it receives data at the second port and immediately transmits the received data from the first port.

In the second mode, the transceiver may process the received data in parallel with the transmission of the received data from its second port.

In the third mode, the transceiver may process the received data in parallel with the transmission of the received data from its first port.

In the first mode, a controller of the transceiver may supply the data to be transmitted from the first and second ports simultaneously.

The data supplied by the controller may be based on a signal received by the controller from a transducer or transducer system coupled to the transceiver.

In the second and third modes, a controller of the transceiver may transmit the received data to a transducer or transducer system coupled to the transceiver.

The first and second ports may be resistively terminated or electrically terminated with elements or circuits that are functionally equivalent to resistive terminations.

The first port may be configured to interface with a transmission medium of a first type.

The second port may be configured to interface with a transmission medium of a second type.

One of the first port and the second port may be couplable to an optical transceiver to permit the transceiver to interface with an optical transmission medium. The other of the first port and the second port may be configured to interface with an electrical transmission medium.

The transceiver may be configured to transition between modes based on data received at the first port or the second port.

The data received at the first port or the second port may comprise a next node symbol or a direction symbol.

According to a second aspect, the invention provides an integrated circuit (IC) implementing a transceiver according to the first aspect.

According to a third aspect, the invention provides a network comprising a plurality of transceivers according to the first aspect coupled to form a daisy-chain network.

Each of the plurality of transceivers may be configured to control its mode of operation based on a network transmission sequence indicative of an order in which the plurality of transducers are permitted to transmit data on the daisy-chain network, such that data transmitted by each transceiver of the plurality of transceivers can be propagated along the daisy-chain network to each of the other transceivers of the plurality of transceivers.

In operation of a transceiver of the network in the first mode of operation, that transceiver may transmit a data frame and a next node symbol from both its ports.

Responsive to receiving a next node symbol indicating that a next transmit opportunity in the network belongs to a transceiver, that transceiver may transition to the first mode of operation.

Responsive to receiving a next node symbol indicating that a next transmit opportunity in the network does not belong to a transceiver, that transceiver may adopt a mode of operation in which a direction of data transmission is away from the transceiver to which the next transmit opportunity belongs.

In operation of a transceiver of the network in the first mode of operation, the transceiver may transmit a data frame and a direction symbol from both its ports.

The plurality of transceivers may be coupled in a ring topology between a second port of a primary transceiver of the plurality of transceivers and a first port of the primary transceiver. The primary transceiver may be configured to monitor data received at its first port to detect a fault in the network.

The network may be configured to emulate a multi-drop network.

The network may be configured to operate the same access control method as a sequential access multi-drop network.

The plurality of transceivers may be coupled by electrically separate half-duplex communication links.

The communication links may comprise twisted pair cable or coaxial cable.

According to a further aspect, the invention provides a host device comprising a transceiver according to the first aspect.

The host device may comprise a vehicle, a car, truck, or other road vehicle, an agricultural vehicle, an industrial vehicle, a train, marine vessel or aircraft, an industrial machine or system, a robot or robotic system, an electronic musical instrument system or component, a commercial audio system or component, a sound reinforcement system or component, an industrial data communication system or component, or a professional audio or audio-visual system.

According to a further aspect, the invention provides a communications network comprising: a first plurality of transceivers according to the first aspect coupled to form a daisy-chain network; and a second plurality of transceivers coupled to a shared medium to form a multi-drop network, wherein a port of a transceiver of the first plurality of transceivers is coupled to the shared medium.

According to a further aspect, the invention provides a transceiver comprising: a first port; a second port; and a processor, wherein in operation of the transceiver, data received at one of the first and second ports is transmitted to the other of the first and second ports and is processed by the processor in parallel with the transmission of the data.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the invention will now be described, strictly by way of example only, with reference to the accompanying drawings, of which:

FIG. 1 is a schematic representation of a transceiver according to the present disclosure;

FIGS. 2a-2d illustrate operating modes of the transceiver of FIG. 1;

FIG. 3 is a schematic representation of a plurality of transceivers according to the present disclosure linearly coupled to form a daisy-chain network;

FIGS. 4a-4d illustrate operation of the daisy-chain network of FIG. 3;

FIG. 5 shows the daisy-chain network of FIG. 3 in a configuration that enables detection of faults;

FIG. 6 shows an example daisy-chain network comprising a plurality of transceivers according to the present disclosure and a transmission sequence for transmission of data by the transceivers;

FIG. 7 shows a further example daisy-chain network comprising a plurality of transceivers according to the present disclosure and a transmission sequence for transmission of data by the transceivers; and

FIG. 8 is a schematic representation of a mixed network comprising a daisy-chain network and a multi-drop network.

### DETAILED DESCRIPTION

Multi-drop twisted-pair buses have become popular, for applications in automotive and industrial systems, for example. In such applications, medium access protocols that grant transmit access sequentially in a fixed topology are becoming popular.

However, some features of such multi-drop (common medium) buses may be disadvantageous in some applications.

For example, multi-drop buses can only have resistive terminations at their end nodes, and intermediate nodes have no terminations. Intermediate nodes' connections to the bus are transmission line stubs of non-trivial length, for typical practical physical system designs. This can pose signal integrity and electromagnetic compatibility (EMC) challenges, even for data rates as low as 10 Mbit/s. This makes it difficult for transceiver (semiconductor) vendors, equipment manufacturers and system integrators to make systems using such technologies that pass EMC emission and immunity standard tests and limits the data bandwidth supported by the multi-drop bus. These limitations can be overcome with advanced signal modulation techniques such as OFDM (Orthogonal Frequency Domain Modulation), but this is very complex and costly to implement in cost-sensitive applications, is highly power-consuming, and has high latency.

Additionally, If the common medium (bus) fails in an open circuit manner, the end termination is no longer present. As a result, all bus communication fails and the master node cannot determine where the fault has occurred to aid fault location.

Further, electrical stubs must be minimised to ensure adequate signal integrity and EMC performance, so these multi-drop buses in practice must have a daisy-chain-like topology, with the common medium T-connection for intermediate nodes very close to the pins of the intermediate transceivers.

The problems may be avoided by instead using a daisy-chain network of separate point-to-point half-duplex connections to implement what is effectively a multi-drop bus using the same cable harness as would be used for a multi-drop bus. Such an arrangement imposes no more restriction on topology than minimising stub lengths on a true multi-drop bus. By manipulating the transmission and forwarding modes of the daisy-chain transceivers dynamically, the system may use the same sequential-access common medium protocols as multi-drop systems, but with better EMC and signal integrity, and therefore higher bit rate and/or easier system integration engineering.

The present disclosure proposes a transceiver for use in a communications network, in particular a half-duplex or daisy-chain network, which can emulate the operation of a multi-drop bus. For example, the communications network may be configured as a daisy-chain network but may operate the same access control method as a sequential access multi-drop network.

The transceiver comprises first and second data ports that are each coupled with both transmit and receive circuitry and thus are each capable of both transmitting and receiving data. The transceiver further comprises a controller having transmit logic and receive logic for controlling transmission and reception of data via the ports.

The transceiver is operable in a plurality of modes. In a first mode of operation, the transceiver is operative (under the control of the controller) to transmit the same data from the first and second ports simultaneously. In a second mode of operation, the transceiver is operative (under the control of the controller) to receive data at its first port and transmit the received data immediately (e.g. without significant intermediate storage or processing) from its second port. In a third mode of operation, the transceiver is operative (under the control of the controller) to receive data at its second port and transmit the received data immediately (e.g. without significant intermediate storage or processing) from its first port.

In the second and third modes of operation, the controller may, in parallel with controlling the reception and transmission of the data, also process and/or monitor the received data, such that the controller can adjust the mode of operation of the transceiver based on the data received at the transceiver.

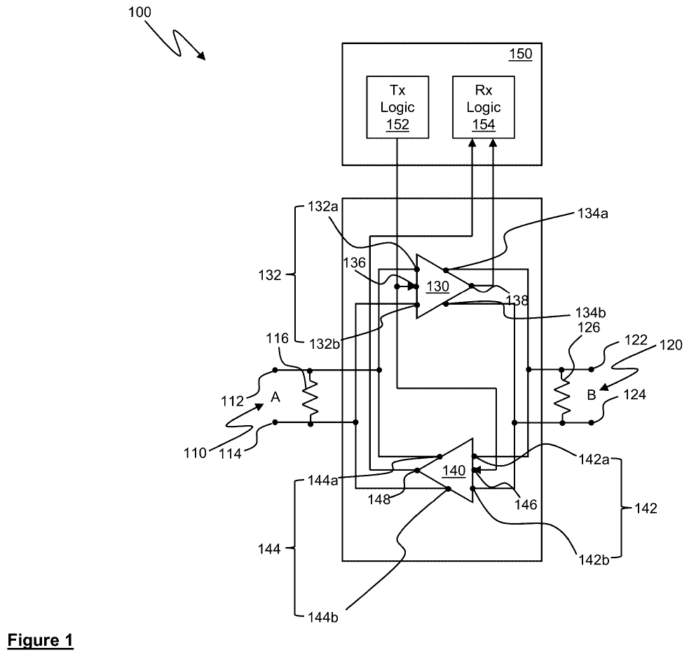

FIG. 1 is a schematic representation of a transceiver according to the present disclosure.

The transceiver, shown generally at 100 in FIG. 1, includes a first bidirectional port 110 (which may also be referred to as port A and is labelled accordingly in FIG. 1) comprising first and second differential signal nodes 112, 114 configured to be electrically coupled to nodes of a port of another similar transceiver in a network such as a daisy-chain network. A first termination resistor 116 or equivalent electrical impedance element or circuit that is functionally equivalent to a termination resistor is provided between the first and second nodes 112, 114 of the first port 110.

The transceiver 100 further includes a second bidirectional port 120 (which may also be referred to as port B and is labelled accordingly in FIG. 1) comprising first and second differential signal nodes 122, 124 configured to be electrically coupled to nodes of a port of another similar transceiver in the network. A second termination resistor 126 or equivalent electrical impedance element or circuit that is functionally equivalent to a termination resistor is provided between the first and second nodes 122, 124 of the second port 120.

The transceiver 100 further includes a first buffer 130. The first buffer 130 has first and second signal inputs 132a, 132b that together constitute a differential pair signal input 132 and first and second signal outputs 134a, 134b that together constitute a differential pair signal output 134. The first buffer 130 also has a single-ended input 136 and a single-ended output 138.

The transceiver 100 further includes a second buffer 140. The second buffer 140 has first and second signal inputs 142a, 142b that together constitute a differential pair signal input 142 and first and second signal outputs 144a, 144b that together constitute a differential pair signal output 144. The second buffer 140 also has a single-ended input 146 and a single-ended output 148.

The first and second differential signal nodes 112, 114 of the first port 110 are coupled to the differential pair signal input 132 of the first buffer 130 and to the differential pair signal output 144 of the second buffer 140 such that the first port 110 is capable of supplying a differential signal to the first buffer 130 and receiving a differential signal from the second buffer 140.

The first and second differential signal nodes 122, 124 of the second port 120 are coupled to the differential pair signal input 142 of the second buffer 140 and to differential pair signal output 134 of the first buffer 130.

The transceiver 100 further includes a processor or controller 150 comprising or implementing transmit logic 152 and receive logic 154. An output of the transmit logic 152 is coupled to the single-ended input 136 of the first buffer 130 and to the single-ended input 146 of the second buffer 140. A first input of the receive logic 154 is coupled to the singled-ended output 138 of the first buffer 130, and a second input of the receive logic 154 is coupled to the single-ended output 148 of the second buffer 140. The transmit and receive logic 152, 154 are operative to control the transmission and reception of data via the ports 110, 120, as will be explained in detail below.

The transceiver 100 may be implemented in integrated circuitry, e.g. as a single integrated circuit (IC). Such an IC may comprise a standalone transducer IC for coupling with additional circuitry, e.g. amplifier circuitry for driving a transducer such as an audio transducer (e.g. a speaker), a haptic transducer or the like. Alternatively, the IC may implement an integrated module that integrates the transceiver 100 with additional circuitry such as amplifier circuitry for driving a transducer such as an audio transducer (e.g. a speaker), a haptic transducer or the like, where the amplifier circuitry is configured to generate an output signal based on data received by the transceiver 100. The IC may be provided as a co-packaged transceiver and amplifier IC, e.g. if the transceiver and the amplifier circuitry are manufactured using different processes.

In the example transceiver 100 of FIG. 1, the first and second ports 110, 120 are both configured to interface with an electrical transmission medium, e.g. a twisted pair cable, a coaxial cable or the like. In alternative examples, the first and second ports 110, 120 may be coupled (directly or indirectly) to transmission media of different types. For example, the first port 110 may be coupled to an optical transceiver to permit the transceiver 100 to interface with an optical transmission medium such as a fibre optic cable, while the second port 120 may be an electrical port configured to interface with an electrical transmission medium such as a twisted pair cable, a coaxial cable or the like. As will be apparent to those of ordinary skill in the art, a transceiver 100 that is capable of interface with different types of transmission media at its first and second ports 110, 120 is able to bridge networks of different types, e.g. an optical network and an electrical network.

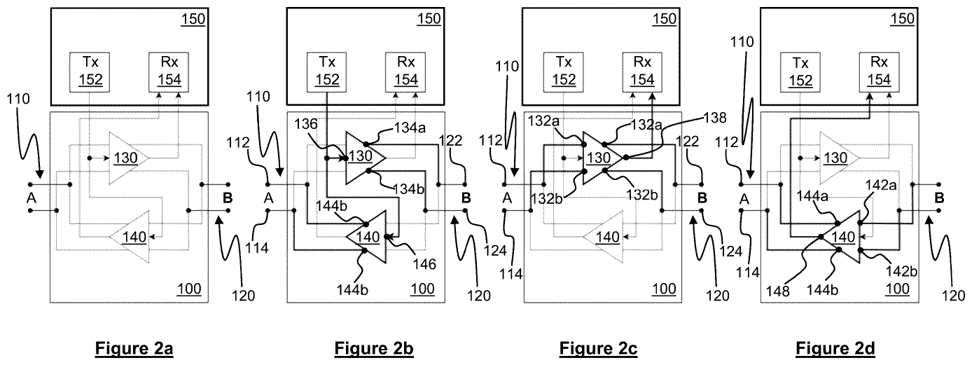

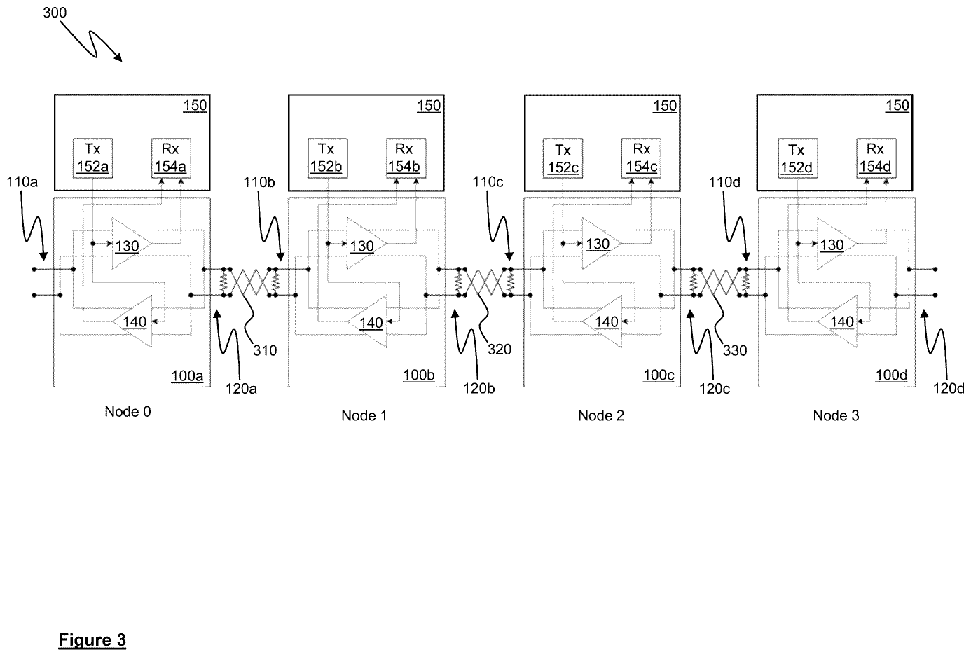

FIGS. 2a-2d illustrate operating modes of the transceiver 100 of FIG. 1.

FIG. 2a shows the transceiver 100 in an inactive state.

FIG. 2b shows a configuration of the transceiver 100 in first mode of operation, which may be referred to as a transmit or TX mode of operation. In this first mode of operation, the transceiver 100 is operative to transmit the same data from both the first port 110 and the second port 120 simultaneously. In this first mode of operation, signal paths from the differential pair signal output 134 of the first buffer 130 to the first and second nodes 122, 124 of the second port 120 and signal paths from the differential pair signal output 144 of the second buffer 140 to the first and second nodes 112, 114 of the first port 110 are active. The controller 150 transmits the data to be transmitted (which may be, for example, audio data based on an audio signal received by the controller 150 from an audio input transducer or transducer system such as a microphone that is coupled to the transceiver 100, or data based on a signal received by the controller 150 from some other transducer or transducer system, such as an accelerometer that is coupled to the transceiver 100) as a single-ended signal to the single-ended inputs 136, 146 of the first and second buffers 130, 140 which in turn transmit the data as a differential signal to the second and first ports 120, 110 respectively, over the active signal paths. In this first mode of operation, the first and second ports 110, 120 thus both operate in a transmit mode.

FIG. 2c shows a configuration of the transceiver 100 in a second mode of operation, which may be referred to as a receive and forward A-B or RXAB mode. In this second mode of operation, the transceiver 100 is operative to receive data (as a differential signal) at the first port 110 and immediately (e.g. without any intentional and/or significant intermediate storage or processing) transmit the received data (as a differential signal) from the second port 120. In this second mode of operation, signal paths from the first and second nodes 112, 114 of the first port 110 to the differential pair signal input 132 of the first buffer 130 and signal paths from the differential pair signal output 134 of the first buffer 130 to the first and second nodes 122, 124 of the second port 120 are active, such that the first port 110 is coupled to the second port 120 via the first buffer 130, to permit the data received at the first port 110 to be transmitted immediately from the second port 120. Thus, in this second mode, the first port 110 operates in a receive mode and the second port 120 operates in a transmit mode. A signal path from the single-ended output 138 of the first buffer 130 to the second input of the receive logic 154 is also active, such that the data received at the first port 110 can be transmitted (as a single ended signal) from the first buffer 130 to the controller 150. The controller 150 may process the received data and transmit the processed data to an output device (e.g. an audio output transducer such as a speaker) that is coupled to the transceiver 100.

Thus, in the second mode of operation, the transceiver 100 transmits or forwards data received at its first port 110 to its second port 120 immediately, and in parallel with this transmission or forwarding of the received data, the controller 150 processes the received data.

FIG. 2d shows a configuration of the transceiver 100 in a third mode of operation, which may be referred to as a receive and forward B-A or RXBA mode. In this third mode of operation, the transceiver 100 is operative to receive data at the second port 120 (as a differential signal) and immediately (e.g. without any intentional and/or significant intermediate storage or processing) transmit the received data from the first port 110. In this third mode of operation, signal paths from the first and second nodes 122, 124 of the second port 120 to the differential pair signal input 142 of the second buffer 140 and signal paths from the differential pair signal output 144 of the second buffer 140 to the first and second nodes 112, 114 of the first port 110 are active, such that the second port 120 is coupled to the first port 110 via the second buffer 140, to permit the data received at the second port 120 to be transmitted immediately from the first port 110. Thus, in this third mode, the first port 110 operates in a transmit mode and the second port 120 operates in a receive mode. A signal path from the single-ended output 148 of the second buffer 140 to the first input of the receive logic 154 is also active, such that the data received at the second port 120 can be transmitted (as a single ended signal) from the second buffer 140 to the controller 150. The controller 150 may process the received data and transmit the processed data to an output device (e.g. an audio output transducer such as a speaker) that is coupled to the transceiver 100.

Thus, in the third mode of operation, the transceiver 100 transmits or forwards data received at its second port 120 to its first port 120 immediately, and in parallel with this transmission or forwarding of the received data, the controller 150 processes the received data.

In the configurations shown in FIGS. 2b-2d the first and second ports 110, 120 of the transceiver 100 are both used for transmission or reception of data. These configurations are for use by a transceiver 100 acting as an intermediate node in a network such as a daisy-chain network. Where the transceiver 100 is used as an end node in a daisy-chain network, it will be operative in a fourth mode of operation, which may be referred to as a receive only (RX) mode. In this fourth mode of operation, only one of the ports 110, 120 is active and coupled to the daisy-chain network. In this fourth configuration, signal paths from the nodes of the active port to the inputs of the associated buffer 130, 140 are active, and a signal path from the output of the buffer 130, 140 to the relevant input of the receive logic 154 is active. For example, if the first port 110 is the active port, signal paths from the first and second nodes 112, 114 of the first port 110 to the inputs of the first buffer 130 and a signal path from the output of the first buffer 130 to the second input of the receive logic 154 are active. Similarly, if the second port 120 is the active port, signal paths from the first and second nodes 122, 124 of the second port 120 to the second buffer 140 and a signal path from the output of the second buffer 140 to the first input of the receive logic 154 are active. In this way the data received at the active port can be transmitted to an output device (e.g. an audio output transducer such as a speaker) that is coupled to the transceiver 100.

The transceiver 100 may switch between modes of operation based on received data to allow use of multi-drop sequential access protocols on a daisy-chained half-duplex network. The transceiver 100 may be used in a daisy-chain based communications network comprising a plurality of electrically separate network links. The network may use sequential access protocols such as a physical layer collision avoidance (PLCA) based protocol. The transceiver 100 may be used in a network of the kind described in U.S. patent application Ser. No. 19/013,618, the contents of which are incorporated by reference herein in their entirety.

FIG. 3 is a schematic representation of a plurality of transceivers of the kind described above with reference to FIGS. 1 and 2 linearly coupled to form a daisy-chain network that may use a sequential access protocol to permit each transceiver to access the network.

As shown generally at 300 in FIG. 3, the daisy-chain network comprises a plurality (in this example four) of transceivers 100a-100d of the kind described above with reference to FIGS. 1 and 2, linearly connected together by electrically separate half-duplex bidirectional links. A first transceiver 100a (which may also be referred to as a Node 0) of the network 300 is disposed at a first end of the network 300 and thus may be referred to as a first end transceiver. Second and third transceivers 100b, 100c (which may also be referred to as Node 1 and Node 2, respectively) are sequentially coupled between the first transceiver 100a and a fourth transceiver 100d (which may also be referred to as Node 3) disposed at a second end of the network 300. The second and third transceivers 100b, 100c may be referred to as intermediate transceivers, and the fourth transceiver 100d may be referred to as a second end transceiver.

To effect the linear coupling of the transceivers 100a-100d, a second port 120a of the first transceiver 100a is coupled to a first port 110b of the second transceiver 100b by a first bidirectional link 310 of a transmission medium such as a twisted pair cable, a coaxial cable or the like. A second port 120b of the second transceiver 100b is coupled to a first port 110c of the third transceiver 100c by a second bidirectional link 320 of a transmission medium such as a twisted pair cable, a coaxial cable or the like, and a second port 120c of the third transceiver 100c is coupled to a first port 110d of the fourth transceiver 100d by a third bidirectional link 330 of a transmission medium such as a twisted pair cable, a coaxial cable or the like.

A second port 120d of the fourth transceiver 100d and a first port 110a of the first transceiver 100a are unconnected. In other examples, the second port 120d of the fourth transceiver 100d may be coupled to the first port 100a of the first transceiver 100a to aid fault detection, as will be described in more detail below. Data may be transmitted between the transceivers 100a-100d over the bidirectional links 310, 320, 330 using any suitable signalling method, e.g. a differential signalling protocol such as differential Manchester encoding or differential Non-Return-to-Zero (NRZ) encoding. The daisy-chain network 300 may be operable as a half-duplex Ethernet network, for example. The daisy-chain network 300 may be operable as an isochronous data transmission network with defined latency.

As will be appreciated by those of ordinary skill in the art, the bidirectional links 310, 320, 330 that couple the first transceiver 100a to the second transceiver 100b, the second transceiver 100b to the third transceiver 100c and the third transceiver 100c to the fourth transceiver 100d, respectively, are electrically separate from each other. The transceivers 100a-100d are connected linearly by the bidirectional links 310, 320, 330. Each bidirectional link 310, 320, 330 permits half-duplex communication between the two adjacent transceivers (nodes) 100a-100d in the daisy-chain network 300. Thus, the intermediate transceivers (transceivers 100b and 100c in the example shown in FIG. 3) each have two ports to connect in both directions along the daisy-chain network 300. The first end transducer 100a can transmit and receive data via its connected second port 120a, while the second end transducer 100d can receive and transmit data via its connected first port 110d.

As noted above, the daisy-chain network 300 uses a sequential access protocol to permit each transceiver 100a-100d to access the network 300. The sequential access protocol effects a predefined transmission sequence in which each transceiver (node) 100a-100d transmits (or is given an opportunity to transmit) a data frame in turn. The predefined transmission sequence may employ a collision avoidance scheme such as the Physical Layer Collision Avoidance algorithm of IEEE standard 802.3-2022 clause 148 “PLCA Reconciliation Sublayer”. The daisy-chain network 300 may be operable to emulate (i.e. operable in the same manner as) the network described in U.S. patent application Ser. No. 19/013,618 (the contents of which are incorporated herein by reference in their entirety), by operating the same access control method as a sequential access multi-drop network.

The daisy-chain network 300 may be used in a variety of applications. For example, the daisy-chain network 300 may be operable as an audio transmission network, e.g. for transmitting audio data between nodes in an automotive environment such as in a vehicle. As another example, the daisy-chain network 300 may be provided as an industrial network, e.g. for transmitting data between nodes in an industrial environment.

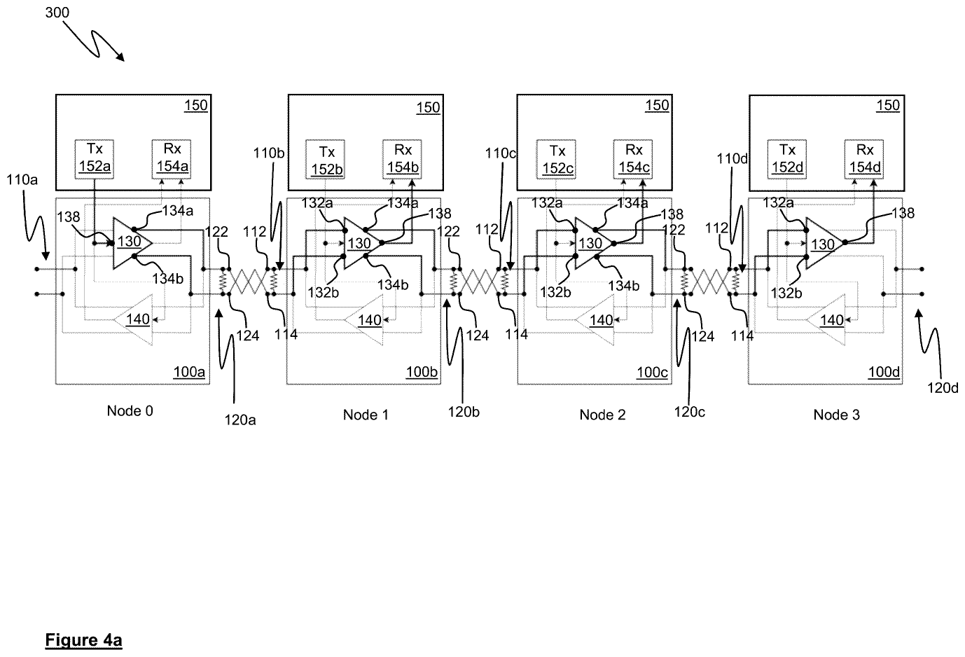

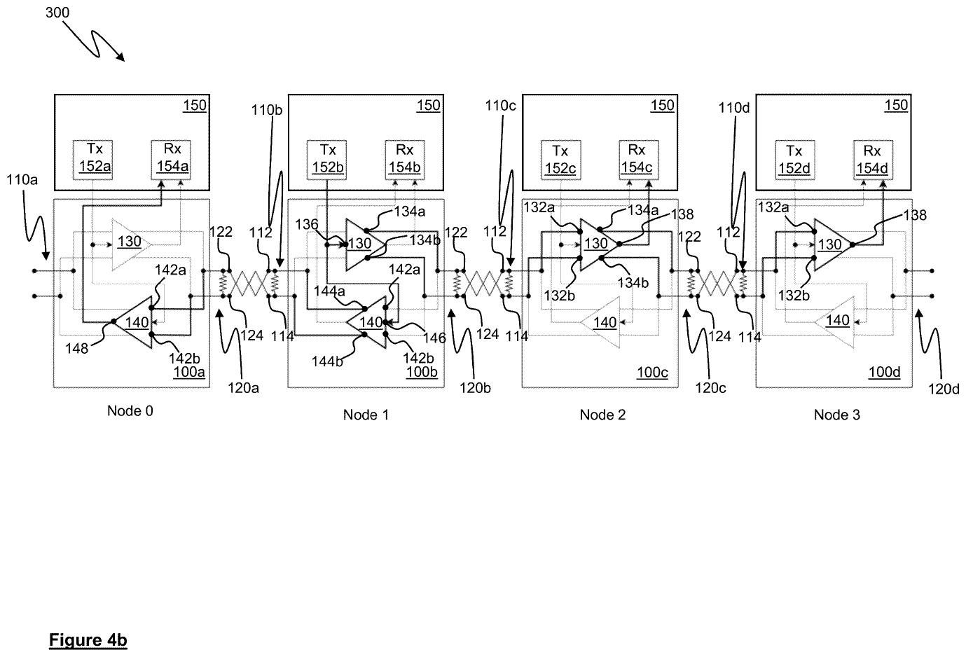

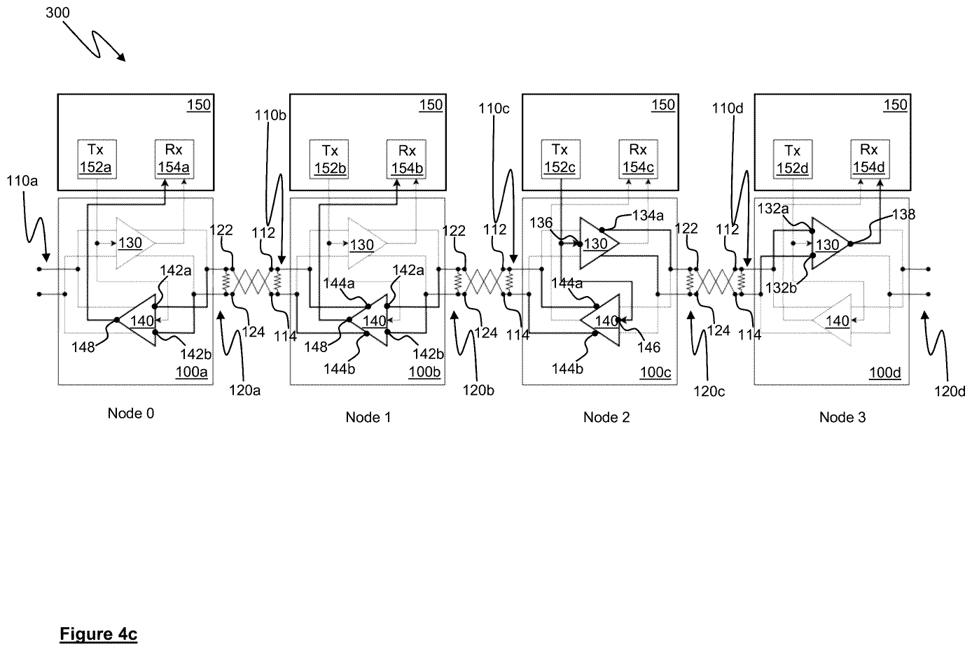

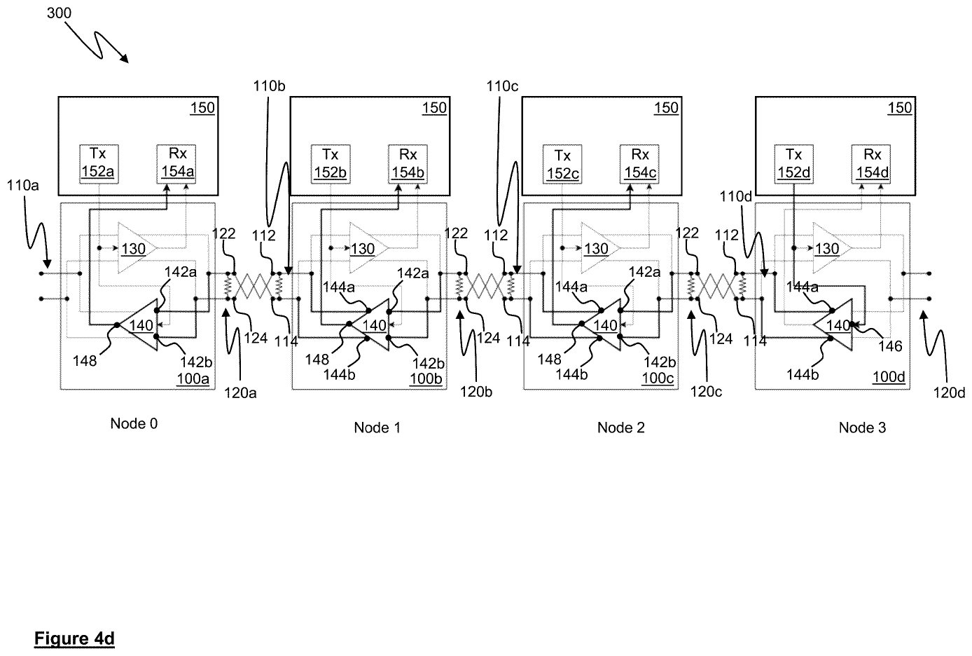

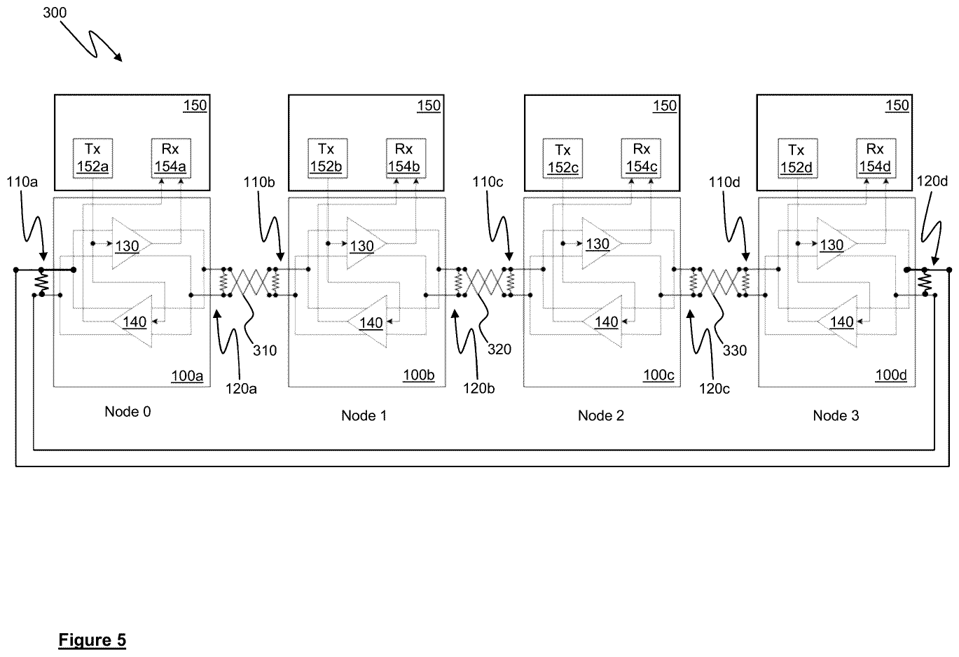

As noted above, the daisy-chain network 300 may use a sequential access protocol, exploiting the ability of the transceivers 100a-100d to adjust their modes of operation to enable the daisy-chain network 300 to emulate a multi-drop bus, as will now be described with reference to FIGS. 4a-4d, which illustrate modes of operation of the transceivers 100a-100d in operation of the daisy-chain network 300.

In the sequential access protocol used by the daisy-chain network 300, a frame transmission cycle may be commenced by the transmission of a beacon signal by the first transceiver (Node 0) 100a. Following the transmission of the beacon signal, the first transceiver (Node 0) has a first opportunity to transmit a frame of data. Each of the transceivers 100b-100d (Nodes 1-3) then transmits (or has an opportunity to transmit) a frame of data in turn. Each transceiver 100a-100d is provided with network information indicative of its own position in the daisy-chain network 300. For example, a node identifier indicative of the position of the transceiver 100a-100d in the daisy-chain network 300 may be stored in memory of or associated with the controller 150. Each transceiver 100a-100d may also store (e.g. in memory of or associated with the controller 150) a predefined transmission sequence indicative of the order in which the transceivers 100a-100d are permitted to transmit data on the daisy-chain network 300.

As shown in FIG. 4a, the frame transmission cycle begins with the first transceiver 100a operating in the first (TX) mode to transmit the beacon signal followed by its data frame from its second port 120a. (Note that the first transceiver 100a does not transmit from its first port 110a in the mode illustrated in FIG. 4a). The second and, third transceivers 100b, 100c operate in the second (RXAB) mode of operation, and the fourth transceiver 100d operates in the fourth (RX) mode of operation.

The second transceiver 100b (Node 1) thus receives the beacon signal and the data frame from the first transceiver 100a (Node 0) at its first port 110b and immediately transmits the received beacon signal and data frame from its second port 120b to the first port 110c of the third transceiver (Node 2) 100c. The second transceiver 100b also transmits the received beacon signal and data frame to its receive logic 154b such that the received data frame can be processed appropriately if it is intended for a transducer coupled to the second transceiver 100b.

The third transceiver 100c (Node 2) receives the beacon signal and the data frame from the second transceiver 100b at its first port 110c and immediately transmits the received beacon signal and data frame from its second port 120c to the first port 110d of the third transceiver (Node 3) 100d. The third transceiver 100c also transmits the received beacon signal and data frame to its receive logic 154c such that the received data frame can be processed appropriately if it is intended for a transducer coupled to the third transceiver 100c.

The fourth transceiver 100d (Node 3) receives the beacon signal and the data frame from the third transceiver 100c at its first port 110d. As the second port 120d of the fourth transceiver 100d is unconnected, the fourth transceiver does not transmit the received beacon signal and the data frame from its second port 120d. The fourth transceiver 100d transmits the received beacon signal and data frame to its receive logic 154d such that the received data frame can be processed appropriately if it is intended for a transducer coupled to the fourth transceiver 100d.

The access protocol used by the network 300 dictates that after the first transceiver (Node 0) 100a has transmitted the beacon signal and its data frame, the second transceiver (Node 1) 100b has an opportunity to transmit a data frame. As all the transceivers have a common, synchronised notion of access protocol state, the first transceiver (Node 0) 100a transitions to the fourth (RX) mode of operation and the second transceiver (Node 1) transitions to the first (TX) mode of operation, while the third transceiver 100c remains in the second (RXAB) mode of operation and the fourth transceiver 100d remains in the fourth (RX) mode of operation, as shown in FIG. 4b.

The second transceiver (Node 1) 100b thus transmits its data frame from both its first port 110b and its second port 120b.

The transmitted data frame is received by the first transceiver (Node 0) 100a at its second port 120a, which transmits the received data frame to its receive logic 154a such that the received data frame can be processed appropriately if it is intended for a transducer coupled to the first transceiver 100a.

The transmitted data frame is also received by the third transceiver (Node 2) 100c, at its first port 110c. The third transceiver 100c immediately transmits the received data frame from its second port 120c to the first port 110d of the fourth transceiver (Node 3) 100d. The third transceiver 100c also transmits the received data frame to its receive logic 154c such that the received data frame can be processed appropriately if it is intended for a transducer coupled to the third transceiver 100c.

The fourth transceiver 100d (Node 3) receives the data frame from the third transceiver 100c at its first port 110d. As the second port 120d of the fourth transceiver 100d is unconnected, the fourth transceiver does not transmit the received data frame from its second port 120d. The fourth transceiver 100d transmits the received data frame to its receive logic 154d such that the received data frame can be processed appropriately if it is intended for a transducer coupled to the fourth transceiver 100d.

The access protocol used by the network 300 dictates that after the second transceiver (Node 1) 100b has transmitted its data frame, the third transceiver (Node 2) 100c has an opportunity to transmit a data frame. Thus, once the second transceiver 100b has transmitted its data frame (or a timeout period for transmitting a data frame has elapsed), the third transceiver (Node 2) 100c transitions to the first (TX) mode of operation, the second transceiver (Node 1) 100b transitions to the third (RXBA) mode of operation, while the first transceiver (Node 0) 100a and the fourth transceiver (Node 3) 100d remain in the fourth (RX) mode of operation, as shown in FIG. 4c.

The third transceiver (Node 2) 100c thus transmits its data frame from both its first port 110c and its second port 120c.

The transmitted data frame is received by the second transceiver (Node 1) at its second port 120b, which immediately transmits the received data frame from its first port 110b to the second port 120a of the first transceiver 100a. The second transceiver 100b also transmits the received data frame to its receive logic 154b such that the received data frame can be processed appropriately if it is intended for a transducer coupled to the second transceiver 100b.

The transmitted data frame is received by the first transceiver (Node 0) 100a at its second port 120a, which transmits the received data frame to its receive logic 154a such that the received data frame can be processed appropriately if it is intended for a transducer coupled to the first transceiver 100a. As the first port 110a of the first transceiver 100a is unconnected, the first transceiver 100a does not transmit the received data frame from its first port 110a.

The data frame is also received by the fourth transceiver 100d (Node 3) at its first port 110d. As the second port 120d of the fourth transceiver 100d is unconnected, the fourth transceiver 100d does not transmit the received data frame from its second port 120d. The fourth transceiver 100d transmits the received data frame to its receive logic 154d such that the received data frame can be processed appropriately if it is intended for a transducer coupled to the fourth transceiver 100d.

The access protocol used by the network 300 dictates that after the third transceiver (Node 2) 100c has transmitted its data frame, the fourth transceiver (Node 3) 100d has an opportunity to transmit a data frame. Thus, once the third transceiver 100c has transmitted its data frame (or a timeout period for transmitting a data frame has elapsed), the fourth transceiver (Node 3) 100d transitions to the first (TX) mode of operation, the third transceiver (Node 2) 100c transitions to the third (RXBA) mode of operation, while the first transceiver (Node 0) 100a remains in the fourth (RX) mode of operation and the second transceiver (Node 1) 100b remains in the third (RXBA) mode of operation, as shown in FIG. 4d.

The fourth transceiver (Node 3) 100d thus transmits its data frame from its first port 110d. As the second port 120d of the fourth transducer 100d is unconnected, the fourth transceiver 100d does not transmit its data frame from its second port 120d.

The transmitted data frame is received by the third transceiver (Node 2) 100c at its second port 120c, which immediately transmits the received data frame from its first port 110c to the second port 120b of the second transceiver 100b. The third transceiver 100c also transmits the received data frame to its receive logic 154c such that the received data frame can be processed appropriately if it is intended for a transducer coupled to the third transceiver 100c.

The transmitted data frame is received by the second transceiver (Node 1) 100b at its second port 120b, which immediately transmits the received data frame from its first port 110b to the second port 120a of the first transceiver 100a. The second transceiver 100b also transmits the received data frame to its receive logic 154b such that the received data frame can be processed appropriately if it is intended for a transducer coupled to the second transceiver 100b.

The transmitted data frame is received by the first transceiver (Node 0) 100a at its second port 120a, which transmits the received data frame to its receive logic 154a such that the received data frame can be processed appropriately if it is intended for a transducer coupled to the first transceiver 100a.

Once the transmission cycle described above and illustrated in FIGS. 4a-4d is complete, the transceivers 100a-100d revert to the configurations shown in described above with reference to FIG. 4a in preparation for a new transmission cycle.

As will be apparent from the discussion above, the transducers 100a-100d of the daisy-chain network 300 are configurable to transmit data one at a time in a predefined transmission sequence.

Each intermediate transceiver 100b, 100c in the daisy-chain network 300 is operable either to transmit the same data on both of its ports (TX mode), or to receive data at its first port and forward or transmit the received data immediately from its second port (RXAB mode), or to receive data at its second port and forward or transmit the received data immediately from its first port (RXBA mode). The mode of operation of the intermediate transceivers 100b, 100c is determined by the controller 150 of each transceiver 100b, 100c and is dependent upon the position of the intermediate transceiver 100b, 100c in the daisy-chain network and a current step in the predefined transmission sequence, i.e. which transceiver 100a-100d is scheduled to transmit a data frame in a current transmit opportunity, according to the predefined transmission sequence.

Each end transceiver 100a, 100d is operable either to transmit data from its connected port or receive data at its connected port. The mode of operation of the end transceivers 100a, 100d is determined by the controller of each transducer 100a, 100d and may be dependent upon the current step in the predefined transmission sequence. In general, the first end transceiver 100a may initially transmit data from its connected port in a first step of the predefined transmission sequence and in subsequent steps of the predefined transmission sequence receive data at its connected port, whereas the second end transceiver 100d may receive data at its connected port in every step of the predefined transmission sequence, and may transmit data from its connected port in the last step in the predefined transmission sequence. The transceivers 100a-100d that are not transmitting in a particular step of the predefined transmission sequence (i.e. those transceivers to which the current transmit opportunity does not belong) are configurable to set their data forwarding direction according to the predefined transmission sequence, such that data is always forwarded or transmitted in a direction away from the transmitting transceiver (i.e. the transceiver that originally transmitted the data), such that the transmitted data propagates to and is received by every transceiver (node) 100a-100d in the daisy-chain network 300.

The ability of the transceivers 100a-100d to dynamically switch their modes of operation according to their position in the daisy-chain network 300 and the predefined transmission sequence enables the daisy-chain network 300 to emulate a multi-drop bus, by operating the same access control method as a sequential access multi-drop network.

The daisy-chain network 300 thus provides many of the benefits of a multi-drop network, including lower cost, complexity and latency than a full-duplex Ethernet network with nodes connected by Ethernet Switches, with improved EMC performance, signal integrity and bandwidth, in comparison to a multi-drop network, because each transceiver 100a-100d of the daisy-chain network 300 is a correctly terminated node of the network due to the provision of first and second termination resistors 116, 126 in each transceiver 100a-100d.

Some sequential medium access protocols support network nodes having no frame to send in a given access cycle. In networks that operate under such protocols, when it is a particular node's turn to transmit a frame (its “transmit opportunity”), the node instead may not transmit. The other nodes may implement a time-out feature for receiving a frame from the node with the current transmit opportunity, and if no frame is received in a defined time-out period, all nodes determine that the transmit opportunity passes on to the next node in the sequence.

In the case of the daisy-chain network 300 described above with reference to FIGS. 3 and 4a-4d, the expiry of the transmit opportunity causes the nodes (transceivers 100a-100d) to change transmission and forwarding modes as necessary, in the same way that the end of a frame transmission would. For example, a node for which a transmit opportunity has expired as a result of a timeout period elapsing may transition to the third (RXBA) mode of operation, while the node to which the current transmit opportunity belongs transitions to the first (TX) mode of operation.

Some sequential access protocols require Node 0 (e.g. the first transceiver 100a in the network 300 described above with reference to FIGS. 3 and 4a-4d) to broadcast a message to all other nodes to command an increment of the transmit opportunity. In such protocols, after the end of a relevant frame has been received, each node (other than node 0) transitions to the second (RXAB) mode, such that it can receive and propagate the next communication transmitted by node 0. The next communication transmitted by node 0 may be, for example, a Transmit Opportunity Increment command or a beacon.

In addition to the operations described above, the daisy-chain network 300 may implement fault detection functionality. Each node may, when operating in the first (transmit) mode, monitor its transmitted data, by comparing data received at that node to the data that was transmitted by the node. If the received data does not match the transmitted data (with an appropriate delay), this can indicate the presence of a fault somewhere in the daisy-chain network 300, or a collision, i.e. two (or more) nodes transmitting simultaneously, e.g. due to an error or failure of the transmission sequence control. This means it is relatively easy for every node to detect faults on its connections. Unlike a multi-drop bus, a line break anywhere on the daisy-chain network 300 does not result in all network communications failing due to a missing termination, because the first and second ports 110, 120 of each transceiver (node) 100a-100d in the daisy-chain network 300 are individually resistively terminated by a termination resistor 116, 126.

In an alternative fault detection arrangement, the second port 120d of the fourth transceiver 100d is coupled to the first port 110a of the first transceiver 100a by a suitable transmission medium such as a twisted pair cable, a coaxial cable or the like, as shown in FIG. 5, such that the transceivers 100a-100d are coupled in a ring network topology between the second port 120a of the first transceiver 100a and the first port 110a of the first transceiver 100a. When the first port 110a of the first transceiver 100a is coupled to the second port 120d of the fourth transceiver 100d in this way the first transceiver 100a does not transmit any data from its first port 110a; the first port 110a is used only for receiving data from the fourth transceiver 100d. The first transceiver (Node 0) 100a is configured as a primary node and is operable to transmit the beacon signal that starts a frame transmission cycle. The other transceivers 100b-100d are configured as secondary nodes which each receive the beacon signal and transmit a respective data frame according to a predefined transmission sequence after the first transceiver 100a has transmitted the beacon signal and its data frame (or a transmit opportunity belonging to the first transceiver 100a has elapsed).

The first transceiver 100a monitors its first port 110a for data frames, but unlike operation in the second (RXAB) mode, it does not forward received frames from its first port 110a to its second port 120a. If the beacon signal or a data frame is received at the first port 100a of the first transceiver 100a within a predefined threshold time period after transmission of a data frame by a transceiver 100a-100d and the received beacon signal matches the beacon signal transmitted by the first transceiver 100a, or if the received data frame matches a data frame transmitted by the first transceiver 100a or a data frame transmitted by another transceiver 100b-100d and received by the first transceiver 100a at its second port 120a, the first transceiver 100a (e.g. the controller 150 of the first transceiver 100a) may determine that no fault is present in the daisy-chain network 300. In contrast, if no data frame is received at the first port 100a of the first transceiver 100a within the predefined threshold time period, or if the data frame does not match a data frame transmitted by the first transceiver 100a or a data frame transmitted by another transceiver 100b-100d and received by the first transceiver 100a at its second port 120a, the first transceiver 100a (e.g. the controller 150 of the first transceiver 100a) may determine that a fault is present in the daisy-chain network 300, and the first transceiver 100a may take further action to identify the location of the fault.

The predefined threshold time period is based on the position of the transmitting transceiver in the daisy-chain network 300, and is configured to account for the time it takes for a data frame transmitted by the transmitting transducer to propagate through the daisy-chain network 300.

Thus, for a data frame transmitted by the first transceiver 100a, the predefined threshold time period may be equal to or based on Tx0+3 (t+I)+Rx0 (where Tx0 is the time for a data frame transmitted by the transmit logic 152a of the first transceiver 100a to reach the second port 120a of the first transceiver 100a, t is the time it takes for a data frame transmitted by a transceiver 100a-100d to propagate through one transceiver 100a-100d, I is the time it takes for a data frame to propagate through one bidirectional link 310, 320, 330, and Rx0 is the time it takes for a data frame received at the first port 110a of the first transceiver 100a to reach the receive logic 154a of the first transceiver 100a), because a data frame transmitted by the first transceiver 100a must propagate through the second, third and fourth transceivers 100b-100d, the bidirectional links 310-330 and the further link between the fourth transceiver 100d and the first transceiver 100a to reach the receive logic 154a of the first transceiver 100a.

Similarly, for a data frame transmitted by the second transceiver 100b, the predefined threshold time period may be equal to or based on Tx1+2 (t+I)+Rx0 (where Tx1 is the time for a data frame transmitted by the transmit logic 152b of the second transceiver 100b to reach the second port 120b of the second transceiver 100b), because a data frame transmitted by the second transceiver 100b must propagate through the third and fourth transceivers 100c-100d, the bidirectional links 320-330 and the further link between the fourth transceiver 100d and the first transceiver 100a to reach the receive logic 154a of the first transceiver 100a.

For a data frame transmitted by the third transceiver 100c, the predefined threshold time period may be equal to or based on Tx2+t+I+Rx0 (where Tx2 is the time for a data frame transmitted by the transmit logic 152c of the third transceiver 100c to reach the second port 120b of the second transceiver 100b), because a data frame transmitted by the third transceiver 100c must propagate through the fourth transceiver 100d, the bidirectional link 330 and the further link between the fourth transceiver 100d and the first transceiver 100a to reach the receive logic 154a of the first transceiver 100a, while for a data frame transmitted by the fourth transceiver 100c, the predefined threshold time period may be equal to or based on Tx3+I+Rx0 (where Tx3 is the time for a data frame transmitted by the transmit logic 152d of the fourth transceiver 100d to reach the second port 120c of the third transceiver 100c), because a data frame transmitted by the fourth transceiver 100d must propagate through the link between the fourth transceiver 100d and the first transceiver 100a to reach the first port 110a of the first transceiver 100a.

If the first transceiver 100a detects a fault in the manner described above, it may take further action to identify the location of the fault. The first transceiver 100a may be able to infer the location of a fault by monitoring the data frames received on its first port 110a, but depending on the nature of the fault and the state of bus traffic, this may not be a reliable way of determining the location of the fault. The first transceiver 100a may be operable to actively validate the location of a fault, by transmitting a fault location detection message, which, when received by each of the other transceivers 100b-100d, changes the transmission mode control sequence to effect a sequential verification of communications between the first transceiver 100a and each other transceiver 100b-100d in turn.

Once the location of the fault has been identified, the first transceiver 100a may take appropriate remedial action to correct or compensate for the fault, e.g. by initiating reconfiguration of the daisy-chain network 300.

In the daisy-chain network described above with reference to FIGS. 3 and 4a the behaviour of each transceiver (node) 100a-100d must correspond to the physical configuration of the daisy-chain network 300, e.g. the order of the transceivers 100a-100d in the daisy-chain network. This may impose a relatively large storage overhead on the transceivers 100a-100d, because each transceiver 100a-100d may be required to store its own unique transmission sequence, which is determined by the position of the transceiver 100a-100d in the daisy-chain network 300 and the predefined transmission sequence for the daisy-chain network 300. Additionally, in the event of a change to the daisy-chain network, e.g. addition or removal of a transceiver, a new unique transmission sequence must be determined and stored for each (remaining) transceiver 100a-100d.

In an alternative approach, each transceiver 100a-100d of the daisy-chain network may be configured to store only information relating to (e.g. an identifier of) a next transceiver 100a-100d in the predefined transmission sequence, and to transmit a next node symbol (e.g. a byte) indicating which transceiver 100a-100d is next in the predefined transmission sequence when it transmits a frame of data. The next node symbol may comprise, for example, scrambled or unscrambled data indicative of the node to which the next transmit opportunity belongs.

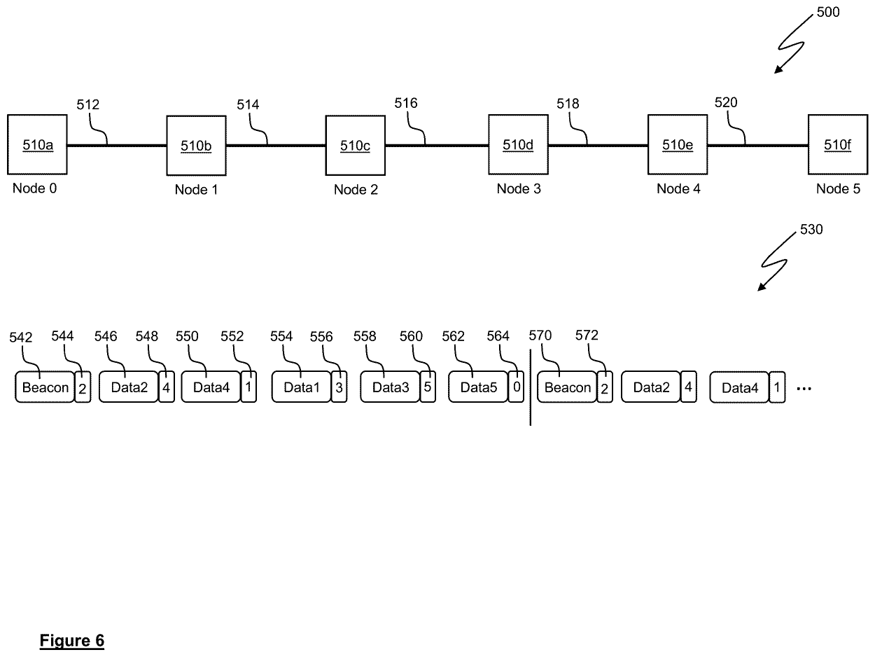

This approach is illustrated schematically in FIG. 6.

FIG. 6 shows an example daisy-chain network 500, comprising first to sixth transceivers 510a-510f of the kind described above with reference to FIGS. 1 and 2, linearly coupled by electrically separate bidirectional half-duplex links 512-520 of a transmission medium such as twisted pair cable, a coaxial cable or the like. Thus, a first transceiver (Node 0) 510a is coupled to a second transceiver (Node 1) 510b by a first bidirectional half-duplex link 512, the second transceiver 510b is coupled to a third transceiver (Node 2) 510c by a second bidirectional half-duplex link 514, the third transceiver 510c is coupled to a fourth transceiver (Node 3) 510d by a third bidirectional half-duplex link 516, the fourth transceiver 510d is coupled to a fifth transceiver (Node 4) 510e by a fourth bidirectional half-duplex link 518 and the fifth transceiver 510e is coupled to a sixth transceiver (Node 5) 510f by a fifth bidirectional half-duplex link 520.

A transmission sequence showing data transmitted by the transceivers 510a-510f is shown generally at 530 in FIG. 6. In the example illustrated in FIG. 6, the transmission sequence does not correspond to the physical order of the transceivers 510a-510e in the daisy-chain network. In this example the transmission sequence is Node 0, Node 2, Node 4, Node 1, Node 3, Node 5. Thus, in this transmission sequence, the first transceiver 510a is the first to transmit data over the network 500, followed by the third transceiver 510c, the fifth transceiver 510e, the second transceiver 510b and the sixth transceiver 510f. Once all the transceivers 510a-510f have transmitted (or had an opportunity to transmit) data, a new transmission sequence starting with the first transceiver 510a commences.

The daisy-chain network is initially configured with the first transceiver 510a as a first end transceiver operating in the first (TX) mode to transmit from its second port. The intermediate transceivers (the second, third, fourth and fifth transceivers 510b-510e) initially operate in the second (RXAB) mode and the sixth transceiver 510f initially operates as a second end mode to receive data at its first port.

In the illustrated transmission sequence, the first transceiver 510a transmits a beacon frame 542 to signal the start of the transmission sequence, followed by a next node symbol 544 with a value 2, indicating that the next transmit opportunity belongs to Node 2 (the third transceiver 510c). After transmitting the beacon frame 542 and the next node symbol 544, the first transceiver transitions to a receive mode of operation in which it receives data at its second port, in preparation for receiving a data frame transmitted by the third transceiver 510c in the next transmit opportunity.

The transmitted beacon frame 542 and next node symbol 544 propagate along the daisy-chain network 500 in the manner described above with reference to FIGS. 3 and 4a-4d.

In response to receiving the next node symbol 544 transmitted by the first transceiver 510a, the second transceivers 510b transitions to the third (RXBA) mode of operation (after forwarding the received beacon frame 542 and next node symbol 544 to the third transceiver 510b), in preparation for receiving a data frame transmitted by the third transceiver 510c in the next transmit opportunity.

In response to receiving the next node symbol 544 transmitted by the first transceiver 510a, the third transceiver 510c transitions to the first (TX) mode of operation (after forwarding the received beacon frame 542 and next node symbol 544 to the fourth transceiver 510d).

In a first transmit opportunity following transmission of the beacon frame 542, the third transceiver (Node 2) transmits a Node 2 data frame 546 and a next node symbol 548 with a value 4, indicating that the next transmit opportunity belongs to Node 4 (the fifth transceiver 510e). After transmitting the Node 2 data frame 546 and the next node symbol 548, the third transceiver transitions to the third (RXBA) mode of operation in preparation for receiving a data frame transmitted by the fifth transceiver 510e in the next transmit opportunity.

The transmitted data frame 546 and next node symbol 548 propagate along the daisy-chain network 500 in the manner described above with reference to FIGS. 3 and 4a-4d.

In response to receiving the next node symbol 548 transmitted by the third transceiver 510c, the fifth transceiver 510e transitions to the first (TX) mode of operation (after forwarding the received data frame 546 and next node symbol 548 to the sixth transceiver 510f) in preparation for transmitting a data frame in the next transmit opportunity.

In response to receiving the next node symbol 548 transmitted by the third transceiver 510c, the fourth transceiver 510d transitions to the third (RXBA) mode of operation (after forwarding the received data frame 546 and next node symbol 548 to the fifth transceiver 510e) in preparation for receiving a data frame transmitted by the fifth transceiver 510e in the next transmit opportunity.

In a second transmit opportunity following transmission of the beacon frame 542, the fifth transceiver (Node 4) 510e transmits a Node 4 data frame 550 and a next node symbol 552 with a value 1, indicating that the next transmit opportunity belongs to Node 1 (the second transceiver 510b). After transmitting the Node 4 data frame 550 and the next node symbol 552, the fifth transceiver 510e transitions to the second (RXAB) mode of operation in preparation for receiving a data frame transmitted by the second transceiver 510b in the next transmit opportunity.

The transmitted data frame 550 and next node symbol 552 propagate along the daisy-chain network 500 in the manner described above with reference to FIGS. 3 and 4a-4d.

In response to receiving the next node symbol 552 transmitted by the fifth transceiver 510e, the second transceiver 510b transitions to the first (TX) mode of operation (after forwarding the received data frame 550 and next node symbol 552 to the first transceiver 510a) in preparation for transmitting a data frame in the next transmit opportunity.

In response to receiving the next node symbol 552 transmitted by the fifth transceiver 510e, the third and fourth transceivers 510c, 510d transition to the second (RXAB) mode of operation (after forwarding the received data frame 550 and next node symbol 552) in preparation for receiving a data frame transmitted by the second transceiver 510b in the next transmit opportunity.

In a third transmit opportunity following the transmission of the beacon frame, the second transceiver (Node 1) 510b transmits a Node 1 data frame 554 and a next node symbol 556 with a value 3, indicating that the next transmit opportunity belongs to Node 3 (the fourth transceiver 510d). After transmitting the Node 1 data frame 554 and the next node symbol 556, the second transceiver 510b transitions to the third (RXBA) mode of operation in preparation for receiving a data frame transmitted by the fourth transceiver 510d in the next transmit opportunity.

The transmitted data frame 554 and next node symbol 556 propagate along the daisy-chain network 500 in the manner described above with reference to FIGS. 3 and 4a-4d.

In response to receiving the next node symbol 556 transmitted by the second transceiver 510b, the fourth transceiver 510d transitions to the first (TX) mode of operation (after forwarding the received data frame 554 and next node symbol 556) in preparation for transmitting a data frame in the next transmit opportunity.

In response to receiving the next node symbol 556 transmitted by the second transceiver 510b, the third transceiver 510c transitions to the third (RXBA) mode of operation (after forwarding the received data frame 554 and next node symbol 556) in preparation for receiving a data frame transmitted by the fourth transceiver 510c in the next transmit opportunity.

In a fourth transmit opportunity following the transmission of the beacon frame, the fourth transceiver (Node 3) 510d transmits a Node 3 data frame 558 and a next node symbol 560 with a value 5, indicating that the next transmit opportunity belongs to Node 5 (the sixth transceiver 510f). After transmitting the Node 3 data frame 558 and the next node symbol 560, the fourth transceiver 510d transitions to the third (RXBA) mode of operation in preparation for receiving a data frame transmitted by the sixth transceiver 510f in the next transmit opportunity.

The transmitted data frame 558 and next node symbol 560 propagate along the daisy-chain network 500 in the manner described above with reference to FIGS. 3 and 4a-4d.

In response to receiving the next node symbol 560 transmitted by the fourth transceiver 510d, the sixth transceiver 510f transitions to the first (TX) mode of operation in preparation for transmitting a data frame in the next transmit opportunity.

In response to receiving the next node symbol 560 transmitted by the second transceiver 510b, the fourth and fifth transceivers 510d, 510e transition to the third (RXBA) mode of operation (after forwarding the received data frame 558 and next node symbol 560) in preparation for receiving a data frame transmitted by the sixth transceiver 510f in the next transmit opportunity.

In a fifth transmit opportunity following the transmission of the beacon frame, the sixth transceiver (Node 5) 510d transmits a Node 5 data frame 562 and a next node symbol 564 with a value 0, indicating that the next transmit opportunity belongs to Node 0 (the first transceiver 510a). After transmitting the Node 5 data frame 562 and the next node symbol 564, the sixth transceiver 510f returns to a receive only mode of operation in preparation for receiving a data frame transmitted by the first transceiver 510a in the next transmit opportunity.

The transmitted data frame 562 and next node symbol 564 propagate along the daisy-chain network 500 in the manner described above with reference to FIGS. 3 and 4a-4d.

In response to receiving the next node symbol 564 transmitted by the sixth transceiver 510f, the first transceiver 510a transitions to the first (TX) mode of operation in preparation for transmitting a beacon frame and/or a data frame in the next transmit opportunity.

In response to receiving the next node symbol 560 transmitted by the second transceiver 510b, the second, third, fourth and fifth transceivers 510b-510e transition to the second (RXAB) mode of operation (after forwarding the received data frame 562 and next node symbol 564) in preparation for receiving a data frame transmitted by the first transceiver 510a in the next transmit opportunity.

The first transceiver 510a then transmits a new beacon frame 570 to signal the start of a new transmission sequence, again followed by a next node symbol 572 with a value 2, indicating that the next transmit opportunity belongs to Node 2 (the third transceiver 510c). The transmission sequence progresses as described above, with the transceivers 510a-510f transitioning between modes according to the next node symbol transmitted by each transceiver 510a-510f in its respective transmit opportunity, to change the direction of data flow in the daisy-chain network 500.

As will be apparent from the discussion above, the use of next node symbols to signal the transceiver (node) 510a-510f to which the next transmit opportunity belongs reduces the storage overhead for each transceiver 510a-510f, because the transceivers 510a-510f do not need to store a full transmission sequence, but instead store only their own node ID and the ID of the next transceiver (node) in the transmission sequence. Thus, the next node symbol approach described above reduces the amount of transmission sequence data that must be stored by each transceiver 510a-510f, at the cost of the addition of the next node symbol to the data transmitted by each transceiver 510a-510f.

If a transceiver 510b-510f is not required by a transmission sequence to transmit a data frame, that transceiver 510b-510f can be skipped, by appropriate selection of next node symbols. Thus, transceivers 510b-510f that are not part of the transmission sequence need not transmit anything and there is no need to wait for a transmit opportunity to expire before a next transceiver in the transmission sequence can transmit its data frame.

Further, the use of the next node symbols ensures that each transceiver 510a-510f in the daisy-chain network 500 is in the correct mode of operation for the direction of data transmission through the network 500 prior to transmission of a data frame, which helps to minimise the latency of the network 500 and obviates any need for adaptive sensing of the direction of data transmission.

Additionally, the use of next node symbols facilitates the addition of transceivers (nodes) to a daisy-chain network. If the next node symbol is one byte, a network of up to 256 network nodes can be supported. If the network includes (or is expanded to include) more than sixteen nodes, the size of the next node symbols can be increased accordingly.

The use of next node symbols also facilitates detection of faults in the daisy-chain network 500. For example, if a data frame is not received at a primary node (e.g. the first transceiver 100a) of the daisy-chain network 500 from a transceiver (node) 100a-100f that was expected to transmit in a particular transmit opportunity, the primary node may determine that a fault has occurred in the transceiver that was expected to transmit.

Next node symbols of the kind described above can also be used to control the behaviour of the daisy-chain network 500. For example, if a primary node (e.g. the first transceiver 500a) transmits a data frame and a next node symbol with a value 0 (indicating that the next transmit opportunity belongs to node 0, i.e. the primary node), this will prevent all the other transceivers (node) 510b-501f on the daisy-chain network from transmitting any data. Similarly, any of the transceivers (nodes) 510a-510f may transmit a data frame followed by a next node symbol with its own node ID as the value of the next node symbol (e.g. node 3 may transmit a data frame followed by a next node symbol with a value 3) to allocate the next transmit opportunity to that transceiver. This may be used to allocate more bandwidth to a particular transceiver in a daisy-chain network which has more data to transmit than other transceivers in the network, for example.

Next node symbols of the kind described above can also be used to detect the configuration of a daisy-chain network (e.g. which nodes are present) and/or for diagnostic purposes. For example, a primary node (e.g. the first transceiver 500a) of the daisy-chain network may ping each transceiver (node) in the network in turn and await a response from that node. Thus, in the example daisy-chain network 500 shown in FIG. 6, the first transceiver 510a may transmit a data frame comprising a ping message and a next node symbol with a value 1, to allocate the next transmit opportunity to the second transceiver (Node 1) 510b. On receiving a response from the second transceiver 510b, the first transceiver 510a may transmit a data frame comprising a ping message and a next node symbol with a value 2, to allocate the next transmit opportunity to the third transceiver (Node 2) 510c. On receiving a response from the third transceiver 510c, the first transceiver 510a may transmit a data frame comprising at ping message and a next node symbol with a value 3, to allocate the next transmit opportunity to the fourth transceiver (Node 3) 510d, and so on. In this way, the first transceiver 500a can detect the transceivers 510b-510f that are present in the daisy-chain network 500. If no response to the ping is received from a transceiver (node) 510b-510f, this may be indicative that there is a fault in that transceiver.

In the example approach described above with reference to FIG. 6, the next node symbol is appended to the beacon or data frame transmitted by a transceiver 510a-510f. In other examples the next node symbol may be transmitted in a different position, e.g. pre-pended to or at the beginning of the beacon or data frame transmitted by a transceiver 510a-510f.

In an alternative approach, instead of transmitting a next node symbol indicative of the node to which the next transmit opportunity belongs with a beacon or data frame, the transceivers in a daisy-chain network may transmit a direction symbol indicative of a direction (left or right) from which the next transmission on the daisy-chain network will come.

The direction symbol is appended to a beacon frame or a data frame transmitted by a transceiver and propagates along the daisy-chain network with the beacon frame or data frame as described above with reference to FIGS. 3 and 4a-4d. Only the transceiver (node) to which the next transmit opportunity belongs is permitted to modify the direction symbol before forwarding it.

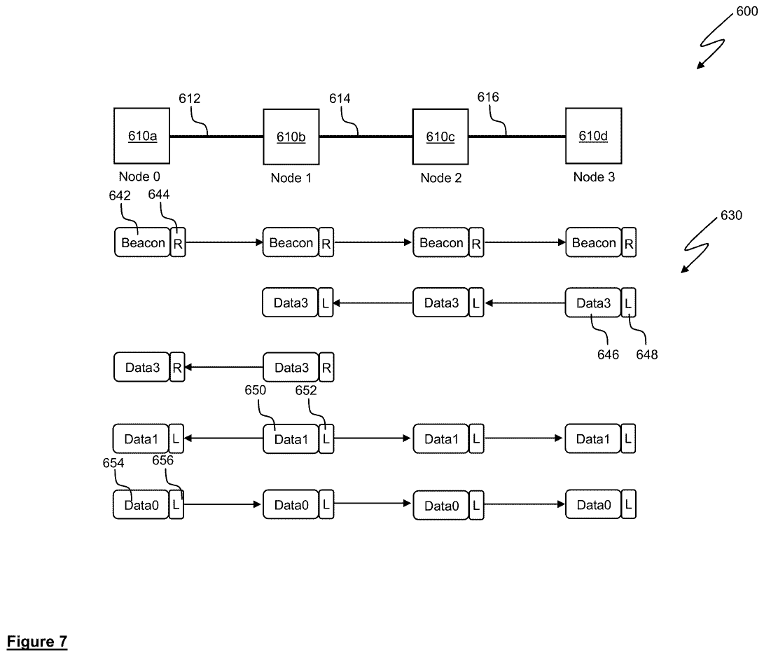

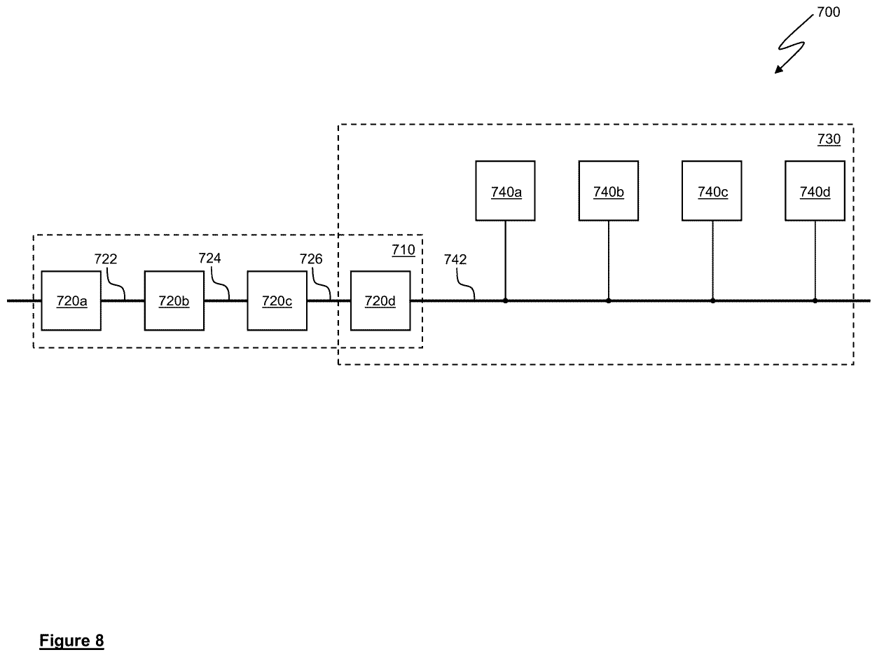

This approach is illustrated schematically in FIG. 7.

FIG. 7 shows an example daisy-chain network 600, comprising first to fourth transceivers 610a-610d of the kind described above with reference to FIGS. 1 and 2, linearly coupled by electrically separate bidirectional half-duplex links 612-616 of a transmission medium such as twisted pair cable, a coaxial cable or the like. Thus, a first transceiver (Node 0) 610a is coupled to a second transceiver (Node 1) 610b by a first bidirectional half-duplex link 612, the second transceiver 610b is coupled to a third transceiver (Node 2) 610c by a second bidirectional half-duplex link 614, and the third transceiver 610c is coupled to a fourth transceiver (Node 3) 610d by a third bidirectional half-duplex link 616.

A transmission sequence showing data transmitted by the transceivers 610a-610d is shown generally at 630 in FIG. 7. In the example illustrated in FIG. 7, the transmission sequence does not correspond to the physical order of the transceivers 610a-610d in the daisy-chain network. In this example the transmission sequence is Node 0, Node 3, Node 1, Node 0. Thus, in this transmission sequence, the first transceiver 610a is the first to transmit data over the network 600, followed by the fourth transceiver 610d, the second transceiver 610b and the first transceiver 610a. On completion of this transmission sequence, a new transmission sequence then commences with transmission of a beacon frame by the first transceiver 610a.

In operation of the example daisy-chain network 600 of FIG. 7, the first transceiver 610a transmits a beacon frame 642 to signal the start of a transmission sequence, followed by a direction symbol 644 with a value “R”, because the next data frame received by the first transceiver 610a will (in accordance with the transmission sequence) be transmitted by the fourth transceiver (Node 3) 610d and will thus come from the right of the first transceiver 610a.

The second and third transceivers 610b, 610c receive the transmitted beacon frame 642 and direction symbol 644 and forward them along the daisy chain network 600 without modifying the direction symbol 644.

The fourth transceiver 610d receives the beacon frame 642 and the direction symbol 644.

In a first transmit opportunity following transmission of the beacon frame 642, the fourth transceiver 610d transmits a Node 3 data frame 646, followed by a direction symbol 648 with a value “L”, because the next data frame received by the fourth transceiver 610d will (in accordance with the transmission sequence) be transmitted by the second transceiver (Node 1) 610b and will thus come from the left of the fourth transceiver 610d.

The third transceiver 610c receives the transmitted Node 3 data frame 646 and the direction symbol 648 and forwards them along the daisy-chain network 600 to the second transceiver 610b without modifying the direction symbol 648.

As the next transmit opportunity belongs to the second transceiver (Node 1) 610b according to the transmission sequence, the second transceiver 610b is permitted to modify the direction symbol 648 before forwarding it to the first transceiver 610a. Thus, the second transceiver 610b modifies the value of the direction symbol 648 to “R” before forwarding the data frame 646 and the direction symbol 648 to the first transceiver 610a, to indicate to the first transceiver (Node 0) 610a that the next data frame it will receive (from the second transceiver (Node 1) 610b) will come from the right of the first transceiver 610a.

In a second transmit opportunity following transmission of the beacon frame 642, the second transceiver (Node 1) 610b transmits a Node 1 data frame 650 followed by a direction symbol 652 with a value “L”, because the next data frame received by the second transceiver 610b will (in accordance with the transmission sequence) be transmitted by the first transceiver (Node 0) 610a and will thus come from the left of the second transceiver 610b.

The third transceiver 610c receives the transmitted Node 1 data frame 650 and the direction symbol 652 and forwards them along the daisy-chain network 600 to the fourth transceiver 610d without modifying the direction symbol 652. The first transceiver 610a also receives the transmitted Node 1 data frame 650 and the direction symbol 652.

In a third transmit opportunity following transmission of the beacon frame 642, the first transceiver (Node 0) 610a transmits a Node 0 data frame 654 followed by a direction symbol 656 with a value “L”, because the next transmission will be a new beacon frame transmitted by the first transceiver (Node 0), which will come from the left of all the other transceivers 610b-610d.

In the event that a time-out period expires for a particular transceiver 600a-600d (i.e. the transceiver does not transmit a data frame in its allotted transmit opportunity), the value of the direction symbol is always set to “L”.

In the approach described above with reference to FIG. 7, each transceiver (node) 610a-610d of the daisy-chain network 600 need only be configured with two parameters, namely the transmit opportunity in the transmission sequence in which it will have an opportunity to transmit a data frame, and information identifying the transceiver (node) to which the immediately subsequent transmit opportunity will belong. This reduces the storage overhead for the transceivers 600a-600d, as each transceiver 600a-600d need not store the full transmission sequence. Additionally, under this there is no need to increase the size of a next node symbol to expand the number of supported nodes in the system, as only a direction symbol (of value “L” or “R”) is required to signal the direction from which the next transmission will arrive.

As noted above, a daisy-chain network of the kind described above with reference to FIGS. 3-7 is able to emulate a multi-drop network, and thus may be employed in applications that may otherwise use a multi-drop network, e.g. in automotive applications such as in-vehicle networks for carrying audio and/or sensor data or in industrial applications such as sensor networks for carrying sensor data.

In some applications, e.g. where a network is required to extend over a large area or distance, a mixed network comprising a daisy-chain network of the kind described above coupled to a multi-drop network may be deployed.

FIG. 8 is a schematic representation of such as mixed network.

As shown generally at 700 in FIG. 8, the mixed network in this example includes a daisy-chain network 710 comprising a first plurality (in this example four) of transceivers 720a-720d of the kind described above with reference to FIGS. 1 and 2a-2d, and a multi-drop network 730 comprising a second plurality (in this example four) of transceivers 740a-740d coupled to multi-drop bus 742 comprising a common transmission medium such as a twisted pair cable, a coaxial cable or the like.

As in the example daisy-chain networks described above with reference to FIGS. 3-7, in the daisy-chain network 710 of FIG. 8, the transceivers 720a-720d are linearly connected together by separate half-duplex bidirectional links 722, 724, 726. Thus, a second port of a first transceiver 720a of the daisy-chain network 710 is coupled to a first port of a second transceiver 720b by a first half-duplex bidirectional link 722. A second port of the second transceiver 720b is coupled to a first port of a third transceiver 720c by a second half-duplex bidirectional link 724, and a second port of the third transceiver 720c is coupled to a first port of the fourth transceiver 720d by a third half-duplex bidirectional link 726.

A second port of the fourth transceiver 720d of the daisy-chain network 710 is coupled to the multi-drop bus 742, such that data transmitted along the daisy-chain network 710 can be transmitted to the transceivers 740a-740d of the multi-drop network 730 via the multi-drop bus 742, and data from any of the transceivers 740a-740d of the multi-drop network 730 can be transmitted to the daisy-chain network 710 via the multi-drop bus 742.

In the mixed network 700 of FIG. 8, after transmitting a data frame in a direction away from the first transceiver 720a, each of the transceivers of the daisy-chain network 710 transitions to the third (RXBA) mode of operation, to permit transmission of data from the transceivers 740a-740d of the multi-drop network 730 in a direction towards the first transceiver 720a.

For example, in a transmission sequence in which a first transmit opportunity belongs to the first transceiver 720a, a second transmit opportunity belongs to the second transceiver 720b, a third transmit opportunity belongs to the third transceiver 720c, a fourth transmit opportunity belongs to the fourth transceiver 720d and the transceivers 740a-740d of the multi-drop bus 730 then transmit data, the mode of operation of each of the transceivers 720a-720d for each transmit opportunity may be as shown in the table below:

| | Mode of | Mode of | Mode of | Mode of |
|---|---|---|---|---|
| | first | second | third | fourth |
| Transmit | transceiver | transceiver | transceiver | transceiver |
| opportunity | 720a | 720b | 720c | 720d |
| 1 | TX | RXAB | RXAB | RXAB |
| 2 | RXBA | TX | RXAB | RXAB |
| 3 | RXBA | RXBA | TX | RXAB |
| 4 | RXBA | RXBA | RXBA | TX |

As described above, the ports of a transceiver 720a-720d may be coupled (directly or indirectly) to transmission media of different types. For example, a first port of the first transceiver 720a may be coupled to an optical transceiver to permit the first transceiver 720a to interface with an optical transmission medium such as a fibre optic cable, while a second port of the first transceiver 720a may be configured to interface with an electrical transmission medium such as a twisted pair cable, a coaxial cable or the like, to enable the (electrical) daisy-chain network 710 to receive data from, and transmit data to, an optical network.

In an alternative arrangement, the daisy-chain network 710 may be an optical network in which the transceivers 720a-720d are linearly connected by separate optical links, while the multi-drop network may be an electrical network which uses an electrical multi-drop bus 742 such as a twisted pair cable, a coaxial cable or the like. The first port of the fourth transceiver 720d of the daisy-chain network 710 may thus be configured to interface with an optical transmission medium, while the second port of the fourth transceiver 720d of the daisy-chain network 710 may be configured to interface with the electrical multi-drop bus 742. In this arrangement the fourth transceiver 720a of the daisy-chain network 710 acts as a bridge between the optical daisy-chain network 710 and the electrical multi-drop network 730.

The following paragraphs describe aspects of the present disclosure.

The present disclosure provides a transceiver for a communications network, the transceiver comprising: first and second data ports, the data ports separately operable in receive or transmit mode; a controller configured to receive data at the data ports and to generate data to be transmitted via the data ports, wherein the transceiver is operable in the following modes: a first passthrough mode where the first port is configured in receive mode and the second port is configured in transmit mode, such that data received at the first port is transmitted at the second port; a second passthrough mode where the second port is configured in receive mode and the first port is configured in transmit mode, such that data received at the second port is transmitted at the first port; and a third access mode, wherein the controller generates data to be transmitted, and wherein the first and second ports are operated in transmit mode such that the generated data is transmitted at the first and second ports, wherein the controller is operable to switch the transceiver between the different modes of operation based on the data received at the first and second ports.

When in the passthrough modes, the received data at one port is transmitted at the other port without intentional storage of the data in between reception and transmission.

The controller is configured to receive data and to process the received data according to the network protocol used for the communications network. The controller may be configured to interface with transducers and/or sensors based on the received data, for example to output an audio stream using a connected loudspeaker.

Preferably, the transceiver is configured for use as one of a plurality of network nodes on a chain-connected bus network, comprising point-to-point half-duplex links connecting transceivers.

Preferably, the controller is configured to derive the order of access of network nodes to the bus network based on the received data. Preferably, the controller is configured to switch the transceiver to the third access mode when it is determined that the transceiver has access to the bus network based on the derived order of access.

Preferably, the transceiver comprises memory storage, wherein network description information is stored in the memory storage, the network description information defining the transceiver's location within a communications network, and wherein the controller is operable to switch the transceiver between the different modes of operation based on the stored network description information.

Preferably, the transceivers are configured to set a data forwarding direction of the transceiver according to a node transmission sequence, such that data is forwarded in a direction away from a transmitting node in the communications network, such that data transmitted by a transmitting node propagates to and may be received by all nodes in a daisy-chain network.

Preferably, the controller is operable to maintain and update a node transmission sequence record based on the received data and the stored network description information, wherein the switching of the transceiver between the different modes of operation is based on the maintained node transmission sequence.

Preferably, the controller is configured to monitor for a data beacon received by the transceiver when in the first or second passthrough modes, and wherein the controller is configured to derive the mode of operation of the transceiver based on the data beacon and data received since the data beacon. The data received may be in the form of data frames received over a network.

In a preferred implementation, the transceiver is for use in a daisy-chain-based communications network, comprising a plurality of electrically separate network links. The network may use sequential access protocols such as a PHY-Layer Collision Avoidance (or PCLA)-based network. The transceiver may be used in a network as described in U.S. patent application Ser. No. 19/013,618, the contents of which are incorporated by reference herein.

The transceiver can be configured to emulate the behaviour of a multi-drop network on a daisy-chain network.

Preferably, when in the third access mode, the controller is configured to monitor data transmitted on the network using receive circuitry of the transceiver during transmission of the generated data, and to compare with the data generated and transmitted by the controller for network fault detection.

Preferably, when the transceiver is in the third access mode, if the controller has no data to be transmitted, the controller holds the first and second data ports inactive for a duration of time.

When in the inactive state, the data ports may be held in a high-impedance state, or the transceiver may be configured to drive the ports with no data.

In a further aspect, the transceiver is further operable in a fourth endpoint mode where the transceiver is configured as an endpoint of a communications network, wherein the controller switches one of the first and second ports between transmit and receive modes and maintains the other of the first and second ports in a low-power or inactive mode, and wherein the controller is operable to switch the one of the first and second ports between transmit and receive modes based on data received at the port.

Preferably, the transceiver is arranged to be coupled with device circuitry, for example a transceiver such as an audio loudspeaker or microphone, wherein the controller is configured to communicate data received from the data ports to the device circuitry, and/or to generate data to be transmitted on the data ports based on signals received from the device circuitry.

There is further provided a communications network comprising a plurality of transceivers as described above connected in a daisy-chain manner to provide a shared network supporting a half-duplex sequential access communications system

There is also provided an integrated circuit (or IC) comprising a transceiver as described above. The IC may comprise a stand-alone transceiver for coupling with additional circuitry, or the IC may comprise an integrated module wherein the transceiver is integrated with an output driver such as an amplifier for driving a transducer, the output driver configured to generate an output signal based on data received by the transducer. The amplifier may comprise an audio amplifier for driving an audio transducer or speaker. Additionally or alternatively, the amplifier may be arranged to drive a haptic transducer.

The IC may be provided as a co-packaged transceiver and output driver, for example if the transceiver and the amplifier are manufactured using different processes.

There is further provided a vehicle comprising the communications network as described above.

The system and/or integrated circuits described above with reference to the accompanying drawings may be incorporated in a vehicle, e.g. as part of a system such as an audio system or component or a road noise cancellation (RNC) system of a car, truck, or other road vehicle, an agricultural vehicle, an industrial vehicle, a train, marine vessel or aircraft, or in another host device such as an industrial machine or system, a robot or robotic system, an electronic musical instrument system or component, a commercial audio system or component, a sound reinforcement system or component, an industrial data communication system or component, a professional audio or audio-visual system, a laptop, notebook, netbook or tablet computer, a gaming device such as a games console or a controller for a games console, a virtual reality (VR) or augmented reality (AR) device, a mobile telephone, a portable audio player or some other portable device, or may be incorporated in an accessory device for use with a laptop, notebook, netbook or tablet computer, a gaming device, a VR or AR device, a mobile telephone, a portable audio player or other portable device.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a System on Chip (SoC), DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog TM or VHDL (Very high speed integrated circuit Hardware Description Language). As the skilled person will appreciate, the code may be distributed between a plurality of coupled components in communication with one another. Where appropriate, the embodiments may also be implemented using code running on a field-(re) programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

As used herein, when two or more elements are referred to as “coupled” to one another, such term indicates that such two or more elements are in electronic communication, optical communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages.

Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A transceiver, the transceiver comprising:
a first port; and
a second port,
wherein the first and second ports are each coupled to transmit circuitry and receive circuitry,
and wherein the transceiver is operable in:
a first mode of operation in which it transmits the same data from the first and second ports simultaneously;
a second mode of operation in which it receives data at the first port and immediately transmits the received data from the second port; and
a third mode of operation in which it receives data at the second port and immediately transmits the received data from the first port.

2. The transceiver of claim 1, wherein:
in the second mode, the transceiver processes the received data in parallel with the transmission of the received data from its second port; and
in the third mode, the transceiver processes the received data in parallel with the transmission of the received data from its first port.

3. The transceiver of claim 1, wherein in the first mode a controller of the transceiver supplies the data to be transmitted from the first and second ports simultaneously.

4. The transceiver of claim 3, wherein the data supplied by the controller is based on a signal received by the controller from a transducer or transducer system coupled to the transceiver.

5. The transceiver of claim 2, wherein in the second and third modes, a controller of the transceiver transmits the received data to a transducer or transducer system coupled to the transceiver.

6. The transceiver of claim 1, wherein the first and second ports are resistively terminated or electrically terminated with elements or circuits that are functionally equivalent to resistive terminations.

7. The transceiver of claim 1, wherein the first port is configured to interface with a transmission medium of a first type and the second port is configured to interface with a transmission medium of a second type.

8. The transceiver of claim 1, wherein one of the first port and the second port is couplable to an optical transceiver to permit the transceiver to interface with an optical transmission medium and the other of the first port and the second port is configured to interface with an electrical transmission medium.

9. The transceiver of claim 1, wherein the transceiver is configured to transition between modes based on data received at the first port or the second port.

10. The transceiver of claim 9, wherein the data received at the first port or the second port comprises a next node symbol or a direction symbol.

11. An integrated circuit (IC) implementing a transceiver according to claim 1.

12. A network comprising a plurality of transceivers according to claim 1 coupled to form a daisy-chain network.

13. The network of claim 12, wherein each of the plurality of transceivers is configured to control its mode of operation based on a network transmission sequence indicative of an order in which the plurality of transducers are permitted to transmit data on the daisy-chain network, such that data transmitted by each transceiver of the plurality of transceivers can be propagated along the daisy-chain network to each of the other transceivers of the plurality of transceivers.

14. The network of claim 12, wherein, in operation of a transceiver of the network in the first mode of operation, that transceiver transmits a data frame and a next node symbol from both its ports.

15. The network of claim 14, wherein, responsive to receiving a next node symbol indicating that a next transmit opportunity in the network belongs to a transceiver, that transceiver transitions to the first mode of operation.

16. The network of claim 15, wherein, responsive to receiving a next node symbol indicating that a next transmit opportunity in the network does not belong to a transceiver, that transceiver adopts a mode of operation in which a direction of data transmission is away from the transceiver to which the next transmit opportunity belongs.

17. The network of claim 12, wherein, in operation of a transceiver of the network in the first mode of operation, the transceiver transmits a data frame and a direction symbol from both its ports.

18. The network of claim 12, wherein the plurality of transceivers are coupled in a ring topology between a second port of a primary transceiver of the plurality of transceivers and a first port of the primary transceiver, and wherein the primary transceiver is configured to monitor data received at its first port to detect a fault in the network.

19. The network of claim 12, wherein the network is configured to emulate a multi-drop network.

20. The network of claim 19, wherein the network is configured to operate the same access control method as a sequential access multi-drop network.

21. The network of claim 12, wherein the plurality of transceivers are coupled by electrically separate half-duplex communication links.

22. The network of claim 21, wherein the communication links comprise twisted pair cable or coaxial cable.

23. A host device comprising a transceiver according to claim 1.

24. A host device according to claim 23, wherein the host device comprises a vehicle, a car, truck, or other road vehicle, an agricultural vehicle, an industrial vehicle, a train, marine vessel or aircraft, an industrial machine or system, a robot or robotic system, an electronic musical instrument system or component, a commercial audio system or component, a sound reinforcement system or component, an industrial data communication system or component, or a professional audio or audio-visual system.

25. A communications network comprising:
a first plurality of transceivers according to claim 1 coupled to form a daisy-chain network; and
a second plurality of transceivers coupled to a shared medium to form a multi-drop network,
wherein a port of a transceiver of the first plurality of transceivers is coupled to the shared medium.

26. A transceiver comprising:
a first port;
a second port; and
a processor,
wherein in operation of the transceiver, data received at one of the first and second ports is transmitted to the other of the first and second ports and is processed by the processor in parallel with the transmission of the data.
